(19) United States
(12) Patent Application Publication
(10) Pub. No.: US 2018/0211350 A1
(43) Pub. Date: Jul. 26, 2018

(54) URBAN ROAD NETWORK ASSET VALUATION METHOD, APPARATUS AND SYSTEM

(71) Applicant: SHIJIAZHUANG TIEDAO UNIVERSITY, Shijiazhuang (CN)

(72) Inventors: Xingju WANG, Shijiazhuang (CN); Yunze WANG, Shijiazhuang (CN)

(73) Assignee: SHIJIAZHUANG TIEDAO UNIVERSITY, Shijiazhuang (CN)

(21) Appl. No.: 15/869,908

(22) Filed: Jan. 12, 2018

(30) Foreign Application Priority Data
Jan. 20, 2017 (CN) 201710048679.5

(51) Int. Cl. G06Q 50/30; G06Q 10/06; G06Q 50/26; G06F 17/10; G06Q 50/08

(52) U.S. Cl. CPC G06Q 50/30; G06Q 10/06393; G06Q 50/08; G06F 17/10; G06Q 50/26

(57) ABSTRACT

A method of an urban road network asset valuation includes: selecting a road network in an urban built-up region as a research object; segmenting each road in the network to different road sections; sequentially calculating the own asset, the epitaxial asset and the utility asset of each road section, the epitaxial asset being a change of an asset of the road section caused by buildings around the road section, and the utility asset being influence of a road section topological structure on the asset of the road section; accumulating the own, epitaxial, and utility assets of the road section to obtain the asset of the road section; accumulating the asset of each road section in one road to obtain the corresponding road asset; and accumulating the asset of each road in the network to obtain the valuated asset of the urban road network in the selected region.

The present invention claims priority of the Chinese Patent Application No. CN201710048679.5 filed to the State Intellectual Property Office on Jan. 20, 2017, entitled ‘URBAN ROAD NETWORK ASSET VALUATION METHOD’, the entire contents of which are incorporated herein by reference.

### FIELD OF THE INVENTION

The present invention relates to the technical field of asset valuation, in particular to an urban road network asset valuation method, apparatus and system.

### BACKGROUND OF THE INVENTION

Roads are important infrastructures for economic development, and the condition of the roads may influence the life-style, life quality and safety of residents, meanwhile, also influences sustainable and steady development of economy and commercial activities of one society, and further shows actual economic strength of one country. Currently, many countries are trying a PPP mode or focus on popularization of the PPP mode, and the PPP mode, i.e., cooperation of the society and social capitals, is a project financing mode in public infrastructures. In such mode, private enterprises and private capitals are encouraged to cooperate with the government and participate in construction of the public infrastructures. Therefore, for those traffic infrastructures, it is necessary to provide a reasonable method for carrying out asset valuation thereon so as to ensure and promote sustainability and economic serviceability of built and newly-built road facilities.

In the field of traffic infrastructure asset valuation, currently, many researches aim at the road asset, the object is only limited to one single road, rather than an integral road network, and there arc only a few valuation methods for the urban road network asset. Currently, for valuation on the road asset, there are mainly three methods as follows:

(1) A market method, which means a method for estimating an asset value by utilizing a recent transaction price of a same kind of asset or a similar asset in the market through direct comparison or analogy analysis and regulation. However, for the road asset, due to different natural and economic environments around, it is difficult to find a reference object with the same or similar characteristics. Due to limitation of application conditions, the market method cannot be applied to urban road network asset valuation.

(2) An earning method, which means an asset valuation method for converting prospective earnings of an asset in future into a current value at present. The earning method shows earnings-generating capacity of the asset, but has no relationship with a net value of the asset. Such valuation method takes the prospective earnings of the asset as the premise, and thus, the earning method can only be used for earning type assets.

(3) A cost method, which means a generic term of various valuation methods for previously estimating replacement cost of an evaluated asset, then carrying out estimation on various existing devaluation factors of the evaluated asset and finally deducting various devaluations from the replacement cost so as to finally obtain a value of the evaluated asset. The cost method evaluates a residual physical value of the asset mainly according to physical construction cost of the asset and an existing state of the asset. It does not consider influence of the environment around roads on the road asset, even does not expand to the integral road network, and ignores a topological structure of the network and thus the cost method is lack of a certain accuracy.

In summary, the existing road asset valuation methods have a certain limitation, and cannot correctly evaluate an urban road network asset.

### THE DETAILED DESCRIPTION

The aim of the present invention is to provide an urban road network asset valuation method, apparatus and system to obtain the urban road network asset by a appropriate valuation in combination with an actual condition of urban road network asset.

In one aspect of the present invention, in order to fulfill the aim, a technical solution is provided as follows: an urban road network asset valuation method comprising the following steps of: selecting a certain road network in an urban built-up region as a research object; segmenting each road in the road network into different road sections; sequentially calculating the own asset, the epitaxial asset and the utility asset of each road section, wherein the epitaxial asset means a change of an asset of the road section, which is caused by buildings around the road section, and the utility asset means influence of road section topological structure on the asset of the road section; accumulating the own asset, the epitaxial asset and the utility asset of the road section to obtain the asset of the road section; accumulating the asset of each road section in one road to obtain the corresponding road asset; and accumulating the asset of each road in the road network to obtain the valuated asset of the urban road network in the selected region.

In another aspect of this invention, in order to fulfill the aim, a technical solution is provided by the present invention, which is as follows: an urban road network asset valuation apparatus comprising a segmentation module, which is used for segmenting a road network in a selected region into at least one road; segmenting each road into at least one road section; a calculation module, which is connected with the segmentation module and used for calculating the own asset, the epitaxial asset and the utility asset of each road section, wherein the epitaxial asset means a change of an asset of the road section, which is caused by buildings around the road section, and the utility asset means influence of road section topological structure on the asset of the road section; and an accumulation module, which is connected with the calculation module and used for accumulating the own asset, the epitaxial asset and the utility asset of each road section to obtain the asset of the road section and used for accumulating the asset of each road section in one road to obtain the corresponding road asset and accumulating the asset of each road in the urban road network to obtain the valuated asset of the urban road network in the selected region.

In yet another aspect, in order to fulfill the aim, a technical solution is provided by the present invention which is as follows: an urban road network asset valuation system comprising a segmentation unit, which is used for segmenting a road network in a selected region into at least one road and segmenting each road into at least one road section; a calculation unit, which is in connection with the segmentation unit and used for calculating the own asset, the epitaxial asset and the utility asset of each road section, wherein the epitaxial asset means a change of an asset of the road section, which is caused by buildings around the road section, and the utility asset means influence of road section topological structure on the asset of the road section; and an accumulation module, which is in connection with the calculation unit and used for accumulating the own asset, the epitaxial asset and the utility asset of each road section to obtain the asset of the road section and used for accumulating the asset of each road section in one road to obtain the corresponding road asset and accumulating the asset of each road in the urban road network to obtain the valuated asset of the urban road network in the selected region.

Based on multiple factors, i.e., the road own asset, the road epitaxial asset and the road utility asset, valuation of the urban road network asset is carried out, so that accuracy and universality of valuation can be improved according to the present invention.

### DESCRIPTION OF THE DRAWINGS

FIG. 1 is a flow chart diagram of a method example of the present invention;

FIG. 2 is a principle chart diagram of an apparatus example of the present invention;

FIG. 3 is a principle chart diagram of a system example of the present invention;

FIG. 4 is a road network topological diagram of a certain built-up region in Shijiazhuang, China.

### EMBODIMENTS

The present invention will be further illustrated in detail in connection with the drawings and particular embodiments.

The asset of a certain road network (the road network should be understood in a maximum range, at least should be a section of an urban road, and at most may consist of hundreds or thousands of urban roads) in a certain urban region needed to be known, the following steps can be referred to and carried out according to the present invention.

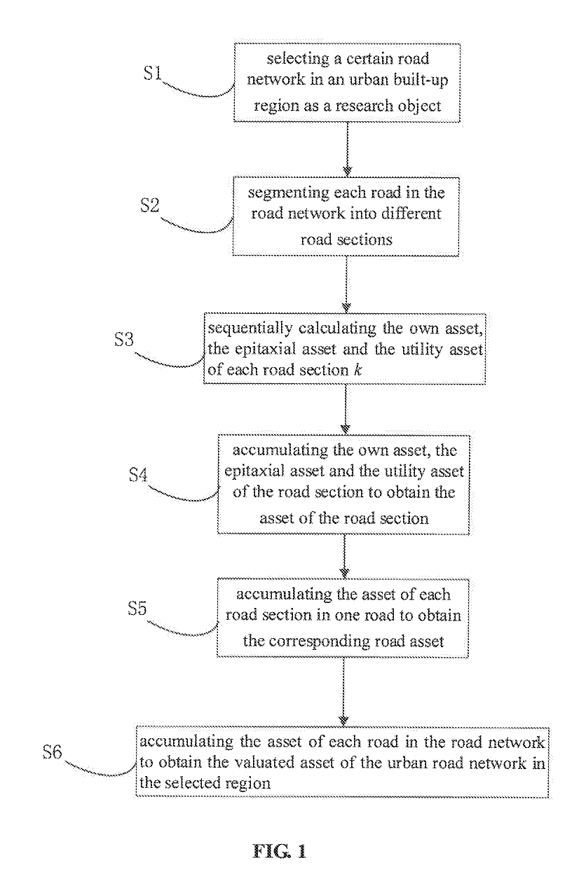

Firstly, as shown in the step S1 of FIG. 1, selecting a certain road network (hereafter abbreviated as road network) in an urban built-up region as a research object, which does not include suburb roads, subordinate country roads and the like.

Next, as shown in the step S2, segmenting each road in the road network into different road sections k, and then as shown in the step S3, determining and calculating three different types of assets of each road section.

Particularly, the own asset R_{K} of each road section k is determined, and a particular method can refer to the following step S2-1 to S2-3.

At the step S2-1, surveying and measuring the length, the width and the number of traffic lanes of each road section k to obtain replacement cost Eₖ of the road section k according to the road reconstruction cost of each traffic lane per kilometer:

Eₖ=LₖAₖI,

in the formula, Lₖ=the number of traffic lanes of the road section k;

Aₖ=the length of the road section k; and

I=the road reconstruction cost of each traffic lane per kilometer.

At the step S2-2, calculating the devaluation on the road section k using Pavement Condition Index (PCI) to obtain a PCI score P_{K} of the road section k, comprising the particular steps of: firstly, carrying out classification on damage (mainly including a crack type, a deformation type and a loose type and the like); then obtaining one-way score deduction value of each type of damages of each road section by values from one-way score deduction table of an asphalt pavement damage (as shown in Table 1) using an interpolation method according to the pavement damage density; finally, accumulating various types of damage to calculate the PCI score P_{K} of the current road section.

At the step S2-3, representing the own asset Rₖ of each road section k as:

$${R}_{k} = {E}_{k} \frac{{P}_{k}}{100} .$$

TABLE 1
One-way Score Deduction Table of Asphalt Pavement Damage

| | | Damage Density/% | | | | | |
|---|---|---|---|---|---|---|---|
| Damage Type | | 0.01 | 0.1 | 1 | 10 | 50 | 100 |
| Crack | Line Crack | 3 | 5 | 8 | 16 | 38 | 48 |
| Type | Net-shaped | 5 | 8 | 10 | 20 | 45 | 70 |
| | Crack | | | | | | |
| | Fragmented | 8 | 10 | 15 | 30 | 55 | 80 |
| | Crack | | | | | | |
| Deformation | Subsidence | 3 | 5 | 12 | 25 | 47 | 63 |
| Type | Rut | 2 | 7 | 12 | 25 | 45 | 55 |
| | Upheaval | 3 | 10 | 15 | 30 | 52 | 65 |
| Loose | Pothole | 10 | 15 | 25 | 40 | 65 | 72 |
| Type | Edge Failure | 2 | 4 | 8 | 15 | 30 | 40 |
| | Spalling | 2 | 5 | 8 | 15 | 35 | 45 |
| Other | Road Frame | 3 | 8 | 12 | 12 | 12 | 12 |
| | Difference | | | | | | |
| | Repaired | 2 | 5 | 8 | 15 | 25 | 33 |
| | Damage | | | | | | |

Next, the epitaxial asset of the road section k is calculated. The epitaxial asset means a change of an asset of the road section caused by buildings around the road section k. By carrying out statistics on market prices and initial construction cost of the buildings around the road section k, such as residence communities, commercial shops and the like, price-added values of the buildings can be obtained, and then according to the replacement cost of each road section, the epitaxial asset Hₖ of the road section k can be obtained as follows:

$${H}_{k} = δ \frac{{Z}_{k}}{C} * {E}_{k}$$

In the formula, δ=regulation coefficient obtained by an expert research method;

C=the construction cost of the buildings in a city; and

Zₖ=an added value of real estate around the road section k.

Particularly, the added value Zₖ is formulated as follows:

Zₖ=Dₖ−C

In the formula, Dₖ=the market price of the buildings around the road section k.

Finally, the utility asset of the road section k is calculated. The utility asset means influence of road section topological structure on the asset of the road section, and can be obtained by two parameters, i.e., Edge Betweenness and traffic volume.

The urban road network consists of a plurality of road sections but each road section is different in importance in the integral road network, and the more important the road section is, the higher the corresponding asset of the road section is. For that reason, the present invention introduces an important measurement index, i.e., the Edge Betweenness, so as to reflect importance of the road section. Particularly, the Edge Betweenness means a proportion of the number of paths in all shortest paths in the road network, which pass through the edge, in the total number of the shortest paths. Assuming that σ_{ab}=the number of shortest paths between the node a and the node b and σ_{ab}^{k}=the number of shortest paths between the node a and the node b passing through the road section k, the Edge Betweenness Bₖ is as follows:

$${B}_{k} = {\sum }_{{a , b ∈ N}_{a \neq b}} ( {σ}_{ab}^{k} / {σ}_{ab} )$$

the length of the path between the node a and the node b is defined as the sum of impedance of all edges which the path includes, when sum of the impedance of all the edges which the path includes is minimum, the path is the shortest path between the node a and the node b, the impedance Wₖ of the road section k is defined as follows:

$${W}_{k} = \frac{1}{{F}_{k}} ;$$

In the formula, Fₖ=service capacity value of the road section k.

The Edge Betweenness depends on the shortest path, and thus, an inverse function 1/Fₖ replaces Fₖ to be used as the impedance of the road section. The present invention uses main landmark buildings in a certain range of the road section as a determinant of measuring service capacity of the road section. A particular method is as follows: firstly, carrying out classification on the landmark buildings in a certain range of each road section according to different functions of the landmark buildings, i.e., government, hospital, school and the like. Then carrying out quantitative valuation on the buildings according to different function of the buildings in grade, and scale. An importance score and the occupied weight of each type of buildings are shown in Table 2. The service capacity of the road section is determined by spatial analysis.

TABLE 2
Importance Scores and The Weight of Various Types of Buildings

| | The Weight of | | |
|---|---|---|---|
| | Buildings in | | |
| | Classification | | Importance |
| Building Type | System | Grade | Score |
| Restaurant | 0.1 | Fast Food Restaurant | 1 |
| | | Casual Restaurant | 3 |
| | | Gourmet Restaurant | 5 |
| Shopping Center | 0.1 | Community Shopping | 1 |
| | | Center | |
| | | Regional Shopping | 3 |
| | | Center | |
| | | Urban Shopping | 5 |
| | | Center | |
| Police Station | 0.1 | County Police | 1 |
| | | Station | |
| | | Municipal Police | 3 |
| | | Station | |
| | | Provincial Police | 5 |
| | | Station | |
| Shopping Mall | 0.1 | Grocery Store | 1 |
| | | Supermarket | 3 |
| | | Giant Supermarket | 5 |
| School | 0.1 | Primary School | 1 |
| | | Middle School | 3 |
| | | University | 5 |
| Hospital | 0.2 | Regional Hospital | 1 |
| | | City Hospital | 3 |
| | | Provincial Hospital | 5 |
| Government | 0.2 | District Government | 1 |
| | | Municipal | 3 |
| | | Government | |
| | | Provincial | 5 |
| | | Government | |
| Hotel | 0.1 | Economy Hotel | 1 |
| | | Mid-level Hotel | 3 |
| | | International Hotel | 5 |

The service capacity value Fₖ of the road section k is defined as follows:

$${F}_{k} = {\sum }_{p ∈ M , q ∈ {Q}_{p}} {α}_{p} {x}_{pq}^{k} ;$$

In the formula, αₚ=the weight of p type of buildings in building classification set M, subject to

$${\sum }_{p ∈ M} {α}_{p} = 1 ;$$

Qₚ^{k}=a set of the p type of buildings around the road section k;

x_{pq}^{k}=a standardized importance score of building q in the p type of buildings around the road section k.

For example, the importance scores of the buildings are divided into 1, 3 and 5, the buildings are subjected to weight allocation according to a case whether the buildings have public functions. Government and hospital have the public functions and have 0.2 weight, and the others respectively have 0.1 weight, and the importance scores and the occupied weight are obtained by a expert research method.

In the p type of buildings around the road section k, the standardized importance score x_{pq}^{k} of the building q is defined as:

$${x}_{pq}^{k} = \frac{{\sum }_{p ∈ M , q ∈ {Q}_{p}^{k}} {y}_{pq}^{k}}{{\sum }_{p ∈ M , q ∈ {Q}_{p}} {y}_{pq}} ;$$

In the formula, y_{pq}=an importance score of the building q in the p type of buildings in the building classification set M;

y_{pq}^{k}=an importance score of the building q in the p type of buildings around the road section k; and

Qₚ=a set of the p type of buildings.

The traffic volume Tₖ of each road section can be obtained by a detector or surveying.

The utility asset is valuated by two parameters, i.e., the Edge Betweenness and the traffic volume, as follows:

Firstly, the Edge Betweenness and the traffic volume are standardized and are changed into dimensionless quantities.

$${β}_{k} = \frac{{B}_{k} - {B}_{min}^{G}}{{B}_{max}^{G} - {B}_{min}^{G}} ; {γ}_{k} = \frac{{T}_{k} - {T}_{min}^{G}}{{T}_{max}^{G} - {T}_{min}^{G}} ;$$

In the formula, Bₘᵢₙ^{G}=the minimum Edge Betweenness in the road network G;

Bₘₐₓ^{G}=the maximum Edge Betweenness in the road network G;

Tₖ=the traffic volume of the road section k;

Tₘᵢₙ^{G}=the minimum traffic volume in the road network G; and

Tₘₐₓ^{G}=the maximum traffic volume in the road network G;

The weight ϕ is given to mean the influence of the Edge Betweenness on the utility asset of the road section, so that the weight is occupied by the traffic volume is (1−ϕ), subject to 0<ϕ<1. Then, the influence effectiveness of the topological structure on the asset of the road section is as ρₖ=ϕ*βₖ+(1−ϕ)*γₖ.

The utility asset Sₖ is defined as:

Sₖ=ρₖ*Eₖ.

So far, as shown in the step S4, an asset Vₖ of the road section k is obtained as follows:

Vₖ=Rₖ+Hₖ+Sₖ.

Next, as shown in the step S5, accumulating the asset of each road section in one road to obtain the corresponding urban road asset; and finally, executing the step S6 to accumulate the asset of each urban road in the road network to obtain the asset of the urban road network in the selected region.

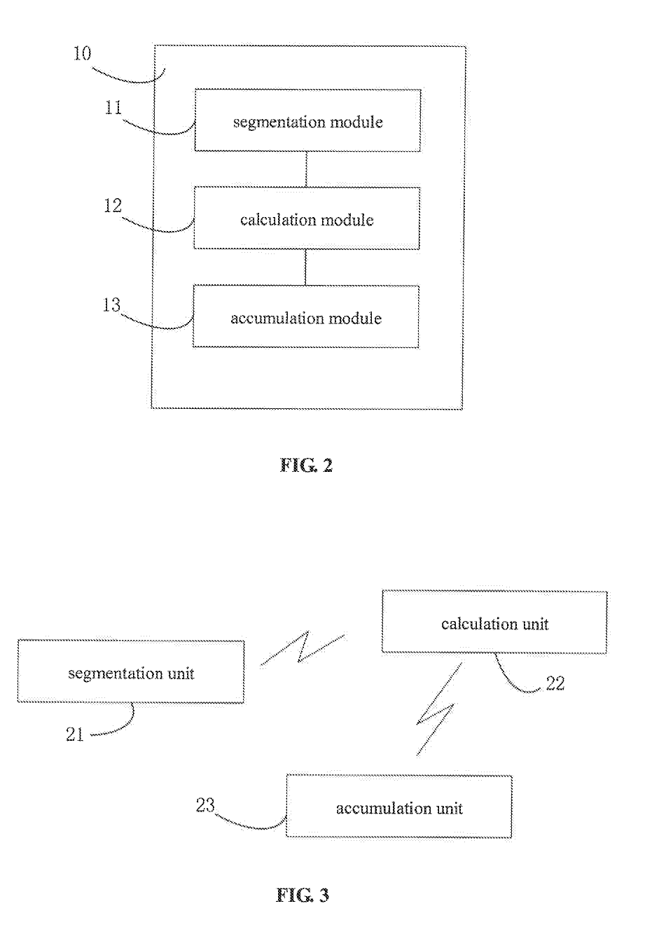

FIG. 2 and FIG. 3 respectively show principle structures of an apparatus example and a system example of the present invention. As in apparatus example 10, the apparatus comprises a segmentation module 11, a calculation module 12 and an accumulation module 13 which are sequentially connected, and correspondingly, the segmentation module 11 executes the step S2 in FIG. 1, the calculation module 12 executes the step S3, and the accumulation module 13 executes the steps S4 to S6. In FIG. 3, the system embodiment comprises a segmentation unit 21, a calculation unit 22 and an accumulation unit 23 by communication connection. The segmentation unit 21 executes the step S2 in FIG. 1, the calculation unit 22 executes the step S3, the accumulation unit 23 executes the step S4 to S6. The different units in the system embodiment shown in FIG. 3 could be distributed at different positions, is not a “separated” physical equipment, but it might be composed of different physical equipment at different positions, that is different from the apparatus embodiment in FIG. 2.

In order to further describe the present invention to enable those skilled in the art to understand the technical solutions of the present invention more clearly, a road network of a certain region in Shijiazhuang in China is taken as an example below, and the asset of the road network is valuated by utilizing the technical solutions provided by the present invention.

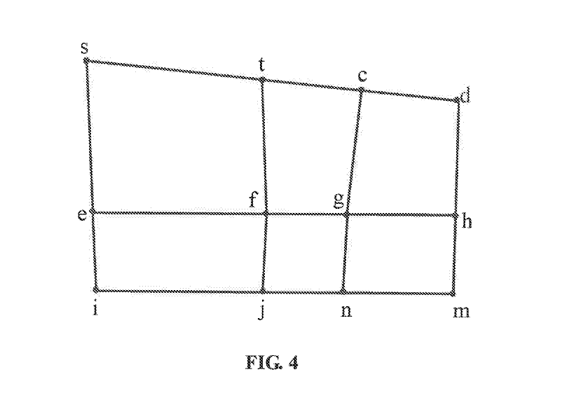

As shown in FIG. 4, the urban road network of the selected region is composed of nodes s, t, c, d, e, f, g, h, i, j, n and m, and particularly includes: Jianshe North Street (s-e-i), Tiyu North Street (t-f-j), Huaqing North Street (c-g-n), Jianhua North Street (d-h-m), Fengshou Road (s-t-c-d), Guanghua Road (e-f-g-h), and Heping East Road (i-j-n-m).

Next, the asset of each road section is calculated, which focuses on taking an s-e road section of Jianshe North Street as an example.

(1) The own asset of the road section is determined, wherein parameters to be determined include the length, the number of the traffic lanes and PCI of the road section. It is assumed that reconstruction cost of each traffic lanes per kilometer is about 400 thousands CNY (Chinese Currency Yuan). Table 3 below shows basic data corresponding to each road section in FIG. 3.

TABLE 3
Basic Data of Part of Road Sections in Road Network in Shijiazhuang

| | | | The Number of | |
|---|---|---|---|---|
| Road | | | traffic Lanes | |
| Section | | Road Section | of Road | |
| Number | Road Section Name | Length (m) | Section | PCI |
| s-e | s-e Road Section of | 376 | 6 | 85 |
| | Jianshe North Street | | | |
| e-i | e-i Road Section of | 131 | 6 | 82 |
| | Jianshe North Street | | | |
| s-t | s-t Road Section of | 325 | 2 | 78 |
| | Fengshou Road | | | |
| t-c | t-c Road Section of | 156 | 2 | 83 |
| | Fengshou Road | | | |
| c-d | c-d Road Section of | 186 | 2 | 75 |
| | Fengshou Road | | | |
| e-f | e-f Road Section of | 365 | 2 | 80 |
| | Guanghua Road | | | |
| f-g | f-g Road Section of | 148 | 2 | 80 |
| | Guanghua Road | | | |
| g-h | g-h Road Section of | 235 | 2 | 76 |
| | Guanghua Road | | | |
| i-j | i-f Road Section of | 313 | 6 | 81 |
| | Heping East Road | | | |
| j-n | j-n Road Section of | 120 | 6 | 86 |
| | Heping East Road | | | |
| n-m | n-m Road Section of | 274 | 6 | 89 |
| | Heping East Road | | | |
| t-f | t-f Road Section of Tiyu | 230 | 6 | 75 |
| | North Street | | | |
| f-j | f-j Road Section of Tiyu | 196 | 6 | 78 |
| | North Street | | | |
| c-g | c-g Road Section of | 240 | 2 | 69 |
| | Huaqing North Street | | | |
| g-n | g-n Road Section of | 185 | 2 | 70 |
| | Huaqing North Street | | | |
| d-h | d-h Road Section of | 296 | 2 | 73 |
| | Jianhua North Street | | | |
| h-m | h-m Road Section of | 172 | 2 | 78 |
| | Jianhua North Street | | | |

By taking the s-e road section of Jianshe North Street as an example, the replacement cost of the s-e road section of Jianshe North Street is calculated as follows (the length unit is converted to km):

Eₛₑ=Lₛₑ*Aₛₑ*I=0.376×6×400000=902400 (CNY)

So that, the own asset of the s-e road section is obtained as follows:

$${R}_{se} = {E}_{se} * \frac{{P}_{se}}{100} = 902400 \times \frac{85}{100} = 76740 ( CNY )$$

(2) The epitaxial asset is calculated, i.e., surveying out prices (unit: CNY (Chinese Currency Yuan) per square meter) of residence communities around the s-e road section of Jianshe North Street (which is subject to statistics in May, 2016).

TABLE 4
Prices of Residence Communities around S-E Road
Section of Jianshe North Street

| Name of Residence | Housing Price | Housing Price in | |
|---|---|---|---|
| Communities | in 2015 | 2016 | Average Price |
| Shangchengyuan | 7779 | 8773 | 8276 |
| Tongxinyuan | 7445 | 7543 | 7494 |
| Yiyuan of Bajia | 6756 | 6832 | 6794 |
| Village | | | |
| Xinhao Town | 8565 | 9036 | 8800.5 |
| Yandu Garden | 8670 | 9160 | 8915 |
| Hongye Garden | 8104 | 8188 | 8146 |
| Boya Manor | 9457 | 10407 | 9932 |

Assuming that reconstruction cost (excluding the land price) of each residence community in Shijiazhuang per square meter is 2000 CNY, the epitaxial asset of the s-e road section of Jianshe North Street is calculated as follows (wherein, the value of a regulation coefficient δ is 1):

$${H}_{se} = [ \frac{( \begin{matrix}8276 + 7494 + 6794 + 8800.5 + \\ 8915 + 8146 + 9932\end{matrix} ) - 2000 \times 7}{2000 \times 7} ] \times 902400 = 2859157.72 ( CNY )$$

(3) calculation of a utility asset: traffic volume and Edge Betweenness are determined.

The traffic volume may be obtained by a detector or surveying. Assuming that traffic volume of cars of the s-e road section of Jianshe North Street is 5000 cars per day, the maximum traffic volume in the road network is 10,000 cars per a day and the minimum traffic volume is 1,000 cars per a day, the traffic volume is standardized into:

$${γ}_{se} = \frac{5000 - 1000}{10000 - 1000} = 0.44 .$$

Edge Betweenness: the landmark buildings around the s-e road section of Jianshe North Street include restaurants, shopping centers, hotels, governments, hospitals and schools, and specific information is as shown in Table 5 for calculation of the Edge Betweenness.

Assuming that there are 100 restaurants (wherein 30 fast food restaurants, 40 casual restaurants and 30 gourmet restaurants), 100 shopping centers (wherein 40 community shopping centers, 40 regional shopping centers and 20 urban shopping centers), 100 hotels (wherein 50 economy hotels, 30 middle-level hotels and 20 international hotels), 50 government agencies (wherein 48 district governments, 1 municipal government and 1 provincial government), 100 hospitals (wherein 50 regional hospitals, 30 city hospitals and 20 provincial hospitals), 100 schools (50 primary schools, 35 middle schools and 15 universities), 30 police stations (wherein 5 county police stations, 20 municipal police stations and 5 provincial police stations), and 100 shopping malls (wherein 50 grocery stores, 40 supermarkets and 10 giant supermarkets) in Shijiazhuang.

TABLE 5
Information of Landmark buildings around S-E Road Section of Jianshe North Street

| | | | Importance | |
|---|---|---|---|---|
| Building Name | Building Type | Grade | Score | Standardized Importance Score |
| Xiangjunfu Jianhua Street Branch | Restaurant | Casual Restaurant | 3 | $\frac{3}{30 \times 1 + 40 \times 3 + 30 \times 5} = 0.01$ |
| Wallace | Restaurant | Fast Food Restaurant | 1 | 0.0033 |
| Guangtian Mansion | Shopping Center | Regional Shopping | 3 | 0.0115 |
| | | Center | | |
| Fuwah Hotel | Hotel | middle-level Hotel | 3 | 0.0125 |
| Shijiazhuang Municipal | Government | District Government | 1 | 0.0179 |
| Quality and Technology | | | | |
| Supervision Bureau | | | | |
| Chang'an Branch | | | | |
| Employment Service | Government | District Government | 1 | 0.0179 |
| Substation in Chang'an | | | | |
| District, Shijiazhuang | | | | |
| Chang'an District Hospital | Hospital | District Hospital | 1 | 0.0042 |
| Kangerle Large Pharmacy | Hospital | Regional Hospital | 1 | 0.0042 |
| Daqiao Foreign Language | School | Middle School | 3 | 0.0130 |
| Jianhua Campus | | | | |
| Mr. Du Arts Training | School | University | 5 | 0.0217 |
| Center Zunyuan Branch | | | | |

Weight allocation of various types of buildings is as follows: the weight of the government is 0.2, the weight of the hospital is 0.2, and the weight of others respectively are 0.1. Then the service capacity value of the s-e road section of Jianshe North Street is:

Fₛₑ=0.01×0.1+0.0033<0.1+0.0115×0.1+0.0125×0.1+0.0179×0.2+0.0179×0.2+0.0042×0.2+0.0042×0.2+0.0130<0.1+0.0217×0.1=0.01604

Therefore, the impedance of the s-e road section of Jianshe North Street is that:

$${W}_{se} = \frac{1}{{F}_{se}} = \frac{1}{0.01604} = 62.3441$$

Impedance of all the road sections can be obtained by applying such method, as shown in Table 6.

TABLE 6
Impedance of Each Road Section

| Road Section | | Road Section |
|---|---|---|
| Number | Road Section Name | Impedance |
| s-e | s-e Road Section of Jianshe | 62.3441 |
| | North Street | |
| e-i | e-i Road Section of Jianshe | 76.2564 |
| | North Street | |
| s-t | s-t Road Section of Fengshou | 73.1259 |
| | Road | |
| t-c | t-c Road Section of | 73.0561 |
| | Fengshou Road | |
| c-d | c-d Road Section of | 80.5218 |
| | Fengshou Road | |
| e-f | e-f Road Section of | 73.1521 |
| | Guanghua Road | |
| f-g | f-g Road Section of | 79.0253 |
| | Guanghua Road | |
| g-h | g-h Road Section of | 78.3651 |
| | Guanghua Road | |
| i-j | i-j Road Section of Hengping | 60.2587 |
| | East Road | |
| j-n | j-n Road Section of | 75.3624 |
| | Hengping East Road | |
| n-m | n-m Road Section of | 74.3259 |
| | Hengping East Road | |
| t-f | t-f Road Section of Tiyu | 79.5656 |
| | North Street | |
| f-j | f-j Road Section of Tiyu | 81.3627 |
| | North Street | |
| c-g | c-g Road Section of Huaqing | 75.3284 |
| | North Street | |
| g-n | g-n Road Section of Huaqing | 75.4895 |
| | North Street | |
| d-h | d-h Road Section of Jianhua | 80.0569 |
| | North Street | |
| h-m | h-m Road Section of Jianhua | 76.3429 |
| | North Street | |

Therefore, the sum of the impedance of all the road sections passed through in a certain path can be obtained, wherein the path with the minimum sum is the shortest path from the place a to the place b, and one or more shortest paths may be provided.

Assuming that in the road network as shown in FIG. 3, the s-e road section of Jianshe North Street is passed through both from the place a to b and from the place c to d. There are 100 paths from the place a to the place b in total, which 30 paths are the minimum and the same with regard to the sum of the impedance of the road sections (i.e., the 30 paths are the shortest paths) and only two paths in the shortest paths pass through the s-e road section of Jianshe North Street. From the place c to the place d, there are 50 paths in total, 20 paths are the shortest paths, and only one path passes through the s-e road section of Jianshe North Street, the Edge Betweenness of the s-e road section of Jianshe North Street is that:

$${B}_{se} = \frac{2 + 1}{30 + 20} = 0.06 .$$

Assuming that in the road network, the maximum Edge Betweenness is 0.5 and the minimum Edge Betweenness is 0.0001, the Edge Betweenness is standardized into:

$${β}_{se} = \frac{0.06 - 0.0001}{0.5 - 0.0001} = 0.1198 .$$

Assuming that the weight of influence of the Edge Betweenness on the utility asset of the road section is 0.6, the traffic volume is 0.4, so the effectiveness of topological structure on the asset of the road section is:

ρₛₑ=0.6×0.1198+0.4×0.44=0.24788

The obtained utility asset is as follows:

Sₛₑ=0.24788×902400=223686.912 (CNY)

(4) Finally, the asset of the s-e road section of Jianshe North Street is calculated as follows:

Vₛₑ=767040+2859157.72+223686.912=3849884.632 (CNY) ≈385 (Ten Thousands CNY)

Assets of other road sections can be obtained according to the calculation method above, as shown in Table 7.

TABLE 7
Asset of Each Road Section

| Road Section | | Road Section Asset |
|---|---|---|
| Number | Road Section Name | (Ten Thousand CNY) |
| s-e | s-e Road Section of Jianshe | 385 |
| | North Street | |
| e-i | e-i Road Section of Jianshe North | 157 |
| | Street | |
| s-t | Ss-t Road Section of Fengshou | 202 |
| | Road | |
| t-c | Tt-c Road Section of Fengshou | 148 |
| | Road | |
| c-d | c-d Road Section of Fengshou | 95 |
| | Road | |
| e-f | e-f Road Section of Guanghua | 254 |
| | Road | |
| f-g | f-g Road Section of Guanghua | 129 |
| | Road | |
| g-h | g-h Road Section of Guanghua | 102 |
| | Road | |
| i-j | i-j Road Section of Hengping | 516 |
| | East Road | |
| j-n | j-n Road Section of Hengping | 127 |
| | East Road | |
| n-m | n-m Road Section of Hengping | 263 |
| | East Road | |
| t-f | t-f Road Section of Tiyu North | 110 |
| | Street | |
| f-j | f-j Road Section of Tiyu North | 95 |
| | Street | |
| c-g | c-g Road Section of Huaqing | 231 |
| | North Street | |
| g-n | g-n Road Section of Huaqing | 179 |
| | North Street | |
| d-h | d-h Road Section of Jianhua | 156 |
| | North Street | |
| h-m | h-m Road Section of Jianhua | 162 |
| | North Street | |

Next, the asset of each road section in each road is accumulated to obtain the asset of the road, as shown in Table 8.

TABLE 8
Asset of Each Road

| | Road Asset |
|---|---|
| Road Name | (Ten Thousand CNY) |
| Jianshe North Street | 542 |
| Fengshou Road | 445 |
| Guanghua Road | 485 |
| Heping East Road | 906 |
| Tiyu North Street | 205 |
| Huaqing North Street | 410 |
| Jianhua North Street | 318 |

The Total asset of the research object road network (the urban road network in the selected region) is calculated as follows:

V=542+445+485+906+205+410+318=3311 (Ten Thousands CNY)

In conclusion, the present invention not only considers the own asset of the roads, but also considers the epitaxial asset of the roads, i.e., the asset is brought by economic conditions around the roads, and the utility asset of the roads, which means influence of the complex degree of the topological structure on the asset of the roads, so that accuracy and universality of valuation can be improved, data support is provided for development planning of the road network in the future, and long-term development of the urban road network is promoted.

Obviously, those skilled in the art can make various changes or modifications to the embodiments of the present invention without departure from the spirit and scope of the embodiments of the present invention. Thus, if these changes and modifications to the embodiments of the present invention are within the scope of the claims of the present invention and equivalent technologies, the present invention also intends to include all such changes and modifications within its scope.

What is claimed is:

1. An urban road network asset valuation method comprising the following steps of:
selecting a certain road network in an urban built-up region as a research object;
segmenting each road in the road network into different road sections;
sequentially calculating an own asset, an epitaxial asset and a utility asset of each road section where the epitaxial asset means a change of an asset of the road section caused by buildings around the road section, the utility asset means the influence of a road section topological structure on the asset of the road section;
accumulating the own asset, the epitaxial asset and the utility asset of the road section to obtain the asset of the road section;
accumulating the asset of each road section in one road to obtain the corresponding road asset; and
accumulating the asset of each road in the road network in the selected region to obtain an valuated asset of the urban road network of the selected region.

2. The method according to claim 1, wherein the own asset of the road section is obtained by subtracting devaluation loss from replacement cost of the road section.

3. The method according to claim 2, wherein the particular step of calculating the own asset of the road section is as follows:
surveying and measuring the length, the width and the traffic lane numbers of each road section k to obtain replacement cost Eₖ of the road section k according to the road reconstruction cost of each traffic lane per one kilometer is formulated as follows:
Eₖ=LₖAₖI,
where Lₖ=the traffic lane numbers of the road section k;
Aₖ=the length of the road section k; and
I=the road reconstruction cost of each road traffic lanes per one kilometer;
calculating the devaluation on the road section k using Pavement Condition Index (PCI) to obtain a PCI score P_{K} of the road section k; thus the own asset Rₖ of the road section k is formulated as follows:
$${R}_{k} = {E}_{k} \frac{{P}_{k}}{100} .$$

4. The method according to claim 3, wherein the calculation step of the PCI score P_{K} is as follows: classifying pavement damage into a crack type, a deformation type and a loose type;
obtaining one-way score deduction value of each type of damages of each road section by values from one-way score deduction table of an asphalt pavement damage using an interpolation method according to the pavement damage density;
accumulating various types of damage to obtain the PCI score P_{K} of the road section.

5. The method according to claim 3, wherein the calculation step of the epitaxial asset Hₖ is as follows:
$${H}_{k} = δ \frac{{Z}_{k}}{C} * {E}_{k} ;$$
in the formula, δ=regulation coefficient obtaining by an expert surveying method;
C=construction cost of the building;
Zₖ=added value of a real estate around the road section k;
the added value Zₖ is formulated as follows:
Zₖ=Dₖ−C
where Dₖ=market price of the buildings around the road section k.

6. The method according to claim 5, wherein in the step of calculating the utility asset of the road section k, firstly, two parameters, Edge Betweenness and traffic volume are defined, the Edge Betweenness means a proportion of the number of paths passing through the edge in the total number of all shortest paths on a road network, and the traffic volume means the number of passing vehicles in a unit time;
next, assuming that σ_{ab}=the number of shortest paths between the node a and the node b, σ_{ab}^{k}=the numbers of shortest paths between the node a and the node b passing through the road section k, the Edge Betweenness Bₖ is formulated as follows:
$${B}_{k} = {{\sum }_{a , b ∈ N}}_{a \neq b} ( {σ}_{ab}^{k} \text{/} {σ}_{ab} ) ;$$
the length of the path between the node a and the node b is defined as the sum of impedance of all edges which the path includes, when sum of the impedance of all the edges which the path includes is minimum, the path is the shortest path between the node a and the node b, the impedance Wₖ of the road section k is defined as follows:
$${W}_{k} = \frac{1}{{F}_{k}} ,$$
Where Fₖ=service capacity value of the road section k;
next the utility asset is valuated by two parameters, Edge Betweenness and traffic volume, the Edge Betweenness and the traffic volume are standardized and are changed into dimensionless quantities:
$${β}_{k} = \frac{{B}_{k} - {B}_{min}^{G}}{{B}_{max}^{G} - {B}_{min}^{G}}$$
$${γ}_{k} = \frac{{T}_{k} - {T}_{min}^{G}}{{T}_{max}^{G} - {T}_{min}^{G}}$$
Where Bₘᵢₙ^{G}=minimum Edge Betweenness in the road network G;
Bₘₐₓ^{G}=maximum Edge Betweenness in the road network G;
Tₖ=traffic volume of the road section k;
Tₘᵢₙ^{G}=minimum traffic volume in the road network G; and
Tₘₐₓ^{G}=maximum traffic volume in the road network G;
next, the weight ϕ is given to mean the influence of the Edge Betweenness on the utility asset of the road section, so that the weight by the traffic volume is (1−ϕ), subject to 0<ϕ<1, the influence effectiveness of the topological structure on the asset of the road section is formulated as ρₖ=ϕ*βₖ+(1−ϕ)*γₖ and the utility asset Sₖ is defined as follows:
Sₖ=ρₖ*Eₖ.

7. The method according to claim 6, wherein the calculation step of the service capacity value Fₖ of the road section k is as follows:
classifying landmark buildings on each road section in a certain range according to different functions of the landmark buildings;
carrying out quantitative valuation on the buildings according to grades and scales of the landmark buildings, and giving an importance score and the occupied weight to each type of buildings; and
through spatial analysis, determining the service capacity value Fₖ of the road section k as follows:
$${F}_{k} = {\sum }_{p ∈ M , q ∈ {Q}_{p}} {α}_{p} {x}_{pq}^{k}$$
Where αₚ=the weight of p type of buildings in building classification set M, subject to
$${\sum }_{p ∈ M} {α}_{p} = 1 ;$$
Qₚ^{k}=set of the p type of buildings around the road section k;
x_{pq}^{k}=standardized importance score of building q in the p type of buildings around the road section k;
in the p type of buildings around the road section k, the standardized importance score of the building q is defined as:
$${x}_{pq}^{k} = \frac{{\sum }_{p ∈ M , q ∈ {Q}_{p}} {y}_{pq}^{k}}{{\sum }_{p ∈ M , q ∈ {Q}_{p}} {y}_{pq}}$$
in the formula, y_{pq}=importance score of the building
q in the p type of buildings in the building classification set M;
y_{pq}^{k}=importance score of the building q in the p type of buildings around the road section k; and
Qₚ=set of the p type of buildings.

8. An urban road network asset valuation apparatus comprising:
a segmentation module used for segmenting a road network in a selected region into at least one road and segmenting each road into at least one road section;
a calculation module connected with the segmentation module and used for calculating the own asset, the epitaxial asset and the utility asset of each road section where the epitaxial asset means a change of an asset of the road section which is caused by buildings around the road section, and the utility asset means influence of a road section topological structure on the asset of the road section; and
an accumulation module connected with the calculation module and used for accumulating the own asset, the epitaxial asset and the utility asset of each road section to obtain the asset of the road section and used for accumulating the asset of each road section in one road to obtain the corresponding road asset and accumulating the asset of each road in the urban road network to obtain the valuated asset of the urban road network in the selected region.

9. An urban road network asset valuation system comprising:
a segmentation unit used for segmenting a road network in a selected region into at least one road and segmenting each road into at least one road section;
a calculation unit in connection with the segmentation unit and used for calculating the own asset, the epitaxial asset and the utility asset of each road section, wherein the epitaxial asset means a change of an asset of the road section caused by buildings around the road section, and the utility asset means influence of a road section topological structure on the asset of the road section; and
an accumulation unit in connection with the calculation unit and used for accumulating the own asset, the epitaxial asset and the utility asset of each road section to obtain the asset of the road section and used for accumulating the asset of each road section in one road to obtain the corresponding road asset and accumulating the asset of each road in the urban road network to obtain the valuated asset of the urban road network in the selected region.
